(19) United States
(12) Patent Application Publication
(10) Pub. No.: US 2010/0332788 A1
(43) Pub. Date: Dec. 30, 2010

(54) AUTOMATICALLY USING SUPERPAGES FOR STACK MEMORY ALLOCATION

(76) Inventors: LI ZHAO, Beaverton, OR (US); Zhen Fang, Portland, OR (US); Ravishankar Iyer, Portland, OR (US); Donald Newell, Portland, OR (US)

Correspondence Address: INTEL CORPORATION;c/o CPA Global, P.O. BOX 52050, MINNEAPOLIS, MN, 55402, US

(21) Appl. No.: 12/495,509

(22) Filed: Jun. 30, 2009

(51) Int. Cl. G06F 12/10; G06F 12/00

(52) U.S. Cl. 711/207; 711/206; 711/E12.001; 711/E12.061

(57) ABSTRACT

In one embodiment, the present invention includes a page fault handler to create page table entries and TLB entries in response to a page fault, the page fault handler to determine if a page fault resulted from a stack access, to create a superpage table entry if the page fault did result from a stack access, and to create a TLB entry for the superpage. Other embodiments are described and claimed.

### BACKGROUND

In modern processors, translation lookaside buffers (TLBs) store address translations from a virtual address (VA) to a physical address (PA). These address translations are generated by the operating system (OS) and stored in memory within page table data structures, which are used to populate the TLB. TLB misses tend to incur a significant time penalty. This problem was explored in “Energy Efficient D-TLB and Data Cache using Semantic-Aware Multilateral Partitioning,” Hsien-Hsin S. Lee and Chinnakrishnan S. Ballapuram, ISLPED '03, Aug. 25-27, 2003, pages 306-311. The proposal to partition a data TLB, however, would require extensive hardware redesign.

### BRIEF DESCRIPTION OF THE DRAWINGS

FIG. 1 is a block diagram of application data in accordance with one embodiment of the present invention.

FIG. 2 is a block diagram of example locations of address translation storage capabilities in accordance with an embodiment of the present invention.

FIG. 3 is a block diagram of the interaction between various components in accordance with an embodiment of the present invention.

FIG. 4 is a flow chart for automatically using superpages for stack memory allocation in accordance with an embodiment of the present invention.

FIG. 5 is a block diagram of a system in accordance with an embodiment of the present invention.

### DETAILED DESCRIPTION

In various embodiments, page table and TLB entries may automatically use superpages for stack memory allocation. One skilled in the art would recognize that this may help prevent stack growth from causing a costly TLB miss and page fault. Many processor designs presently include the ability to create superpages with some designs limiting their use to certain TLB entries. The present invention is intended to be practiced with any TLB design that provides for superpages (or pages that reference larger portions of memory than a normal size page).

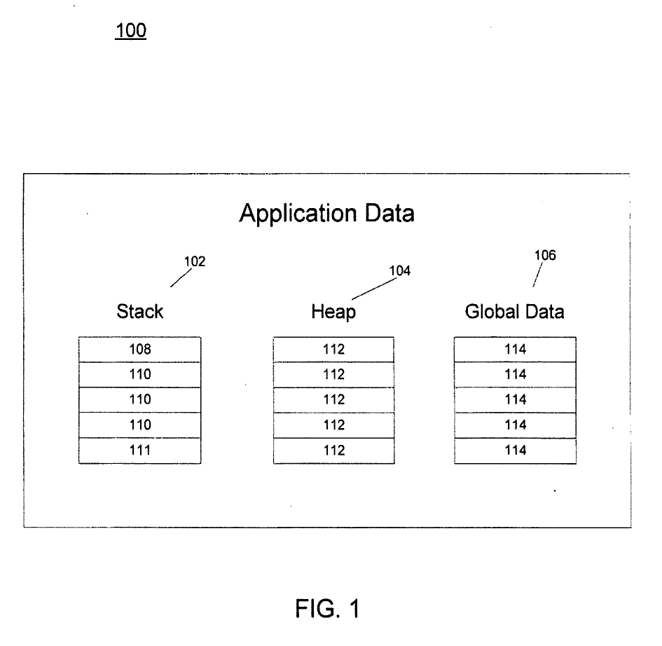

Referring now to FIG. 1, shown is a block diagram of application data in accordance with one embodiment of the present invention. As shown in FIG. 1, application data 100 may include stack 102 with bottom entry 108, following entries 110 and top entry 111, heap 104 with heap entries 112 and global data 106 with global data entries 114. Stack 102 may grow as following entries 110 are pushed onto the stack, increasing the amount of memory needed to support stack 102. Bottom entry 108 would have a known address upon which following entries are added. A pointer, for example a register, may maintain a current top address for top entry 111.

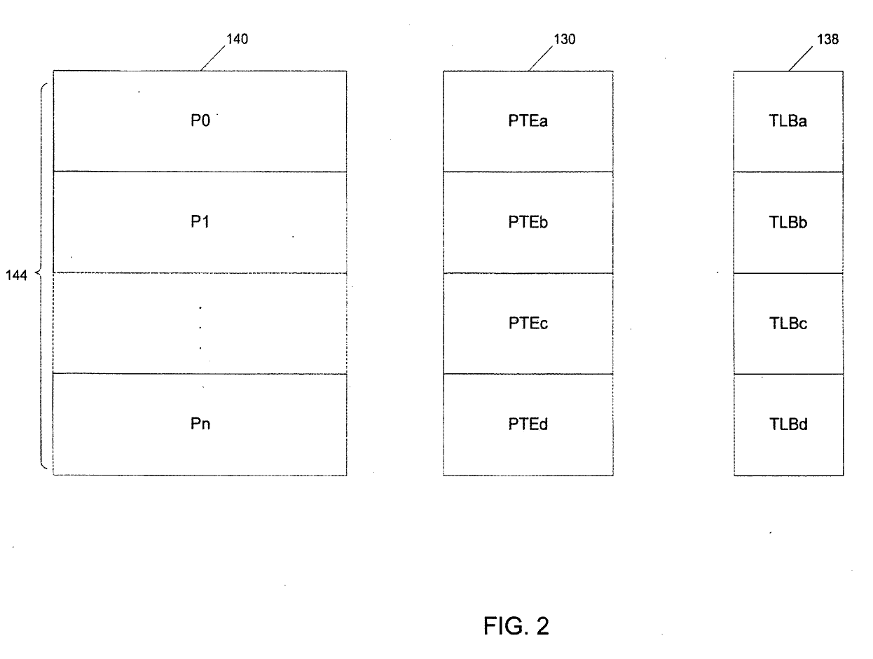

Referring now to FIG. 2, shown is a block diagram of example locations of address translation storage capabilities in accordance with an embodiment of the present invention. As shown in FIG. 2, main memory 140 may include multiple page frames in a page frame storage area 144. More specifically, page frames P₀-P_{N} may be present. Page table 130 may store various page table entries, PTE_{A-D}, each of which may correspond to one of the page frames P_{X} stored in page frame area 144. TLB 138 may store various TLB entries, TLB_{A-D}, each of which may correspond to one of the page table entries, PTE_{A-D}, for one of the page frames P_{X} stored in page frame area 144. Page frames P₀-P_{N} may have consistently spaced boundaries or may come in various sizes. In one embodiment, page table 130 may contain entries that reference superpages, for example multiple contiguous page frames, for example, P₀-P₄. In one embodiment, normal size page frames P₀-P_{N} are 4 kilobytes in size while superpages are 2 megabytes in size (or 512 contiguous normal size page frames). In one embodiment, a superpage can have a size chosen from a predetermined group of sizes, for example a superpage may be able to scale to any one of 8K, 64K, 512K, or 4M. TLB 138 may have certain entries designated for referencing superpages or may limit the number of entries that may reference superpages.

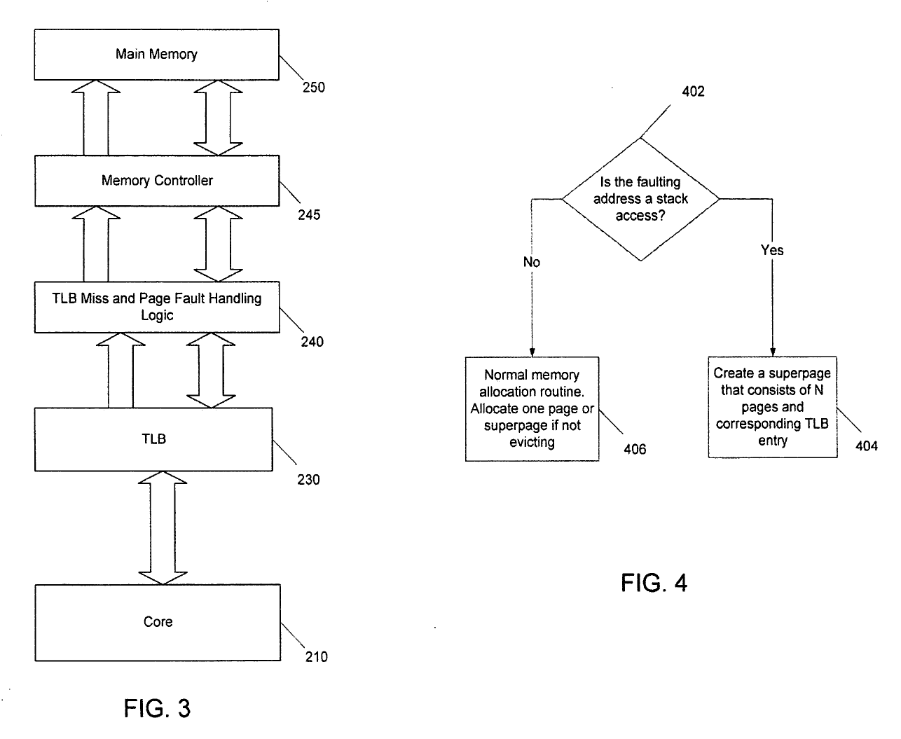

Referring now to FIG. 3, shown is a block diagram of an interaction between various components in accordance with an embodiment of the present invention. As shown in FIG. 3, to map memory addresses various components may interact. Specifically, the core may request information present in a particular page of main memory 250. Accordingly, core 210 provides an address to both a TLB 230 (which includes translation information. If the corresponding PA-to-VA translation is not present in TLB 230, a TLB miss may be indicated and if there is no page table entry a page fault would occur. This would be handled by TLB miss and page fault handling logic (TMPFHL) 240 which in turn may provide the requested address to a memory controller 245 which in turn is coupled to main memory 250 to thus enable loading of a page table entry into TLB 230. TMPFHL 240 may implement a method for automatically using superpages for stack memory allocation as shown below in reference to FIG. 4. TMPFHL 240 may be implemented in OS kernel software or firmware or hardware or a combination of hardware or software.

Referring now to FIG. 4, shown is a flow chart for automatically using superpages for stack memory allocation in accordance with an embodiment of the present invention. As shown in FIG. 4, the method begins with responding to a page fault by determining (402) whether a faulting address is a stack access. In one embodiment, TMPFHL 240 determines whether or not a faulting address is a stack access by comparing the faulting address to the address of stack top entry 111 to decide if the address is a stack access. In another embodiment, TMPFHL 240 determines that a faulting address is a stack access if the architectural register that is used to pass the faulting address is the frame pointer, for example EBP, or the stack pointer, for example ESP. In another embodiment, TMPFHL 240 determines whether or not a faulting address is a stack access by looking at the highest order bit of a user-mode application's address. If the most significant bit of the faulting address is a 1, then it is a stack access. In another embodiment, the load/store instruction carries a special bit to explicitly tell TMPFHL 240 whether or not the faulting address is a stack access. If the page fault did result from a stack access, then TMPFHL 240 would create (404) a superpage for the access in page tables 130 and a corresponding entry in TLB 138.

If it is determined that the page fault did not result from a stack access, then TMPFHL 240 would follow (406) a different memory allocation routine. In one embodiment, the memory allocation routine for a non-stack access would be to create one normal size page in page tables 130. In another embodiment, the memory allocation routine for a non-stack access would be to create a superpage in page tables 130.

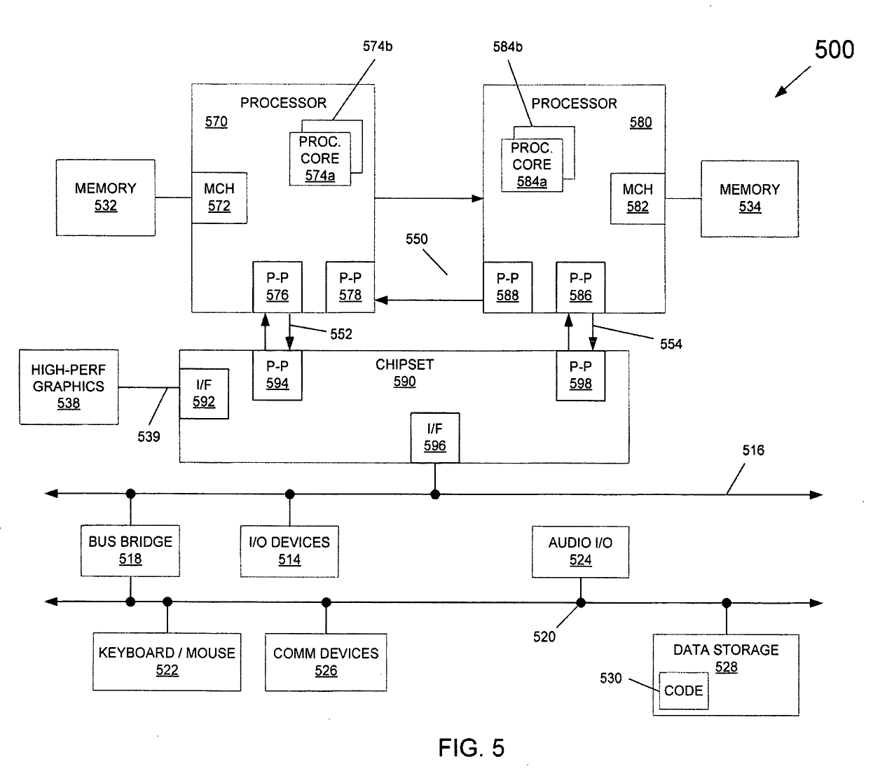

Embodiments may be implemented in many different system types. Referring now to FIG. 5, shown is a block diagram of a system in accordance with an embodiment of the present invention. As shown in FIG. 5, multiprocessor system 500 is a point-to-point interconnect system, and includes a first processor 570 and a second processor 580 coupled via a point-to-point interconnect 550. As shown in FIG. 5, each of processors 570 and 580 may be multicore processors, including first and second processor cores (i.e., processor cores 574a and 574b and processor cores 584a and 584b). Each processor may include TLB hardware, software, and firmware in accordance with an embodiment of the present invention.

Still referring to FIG. 5, first processor 570 further includes a memory controller hub (MCH) 572 and point-to-point (P-P) interfaces 576 and 578. Similarly, second processor 580 includes a MCH 582 and P-P interfaces 586 and 588. As shown in FIG. 5, MCH's 572 and 582 couple the processors to respective memories, namely a memory 532 and a memory 534, which may be portions of main memory (e.g., a dynamic random access memory (DRAM)) locally attached to the respective processors, each of which may include extended page tables in accordance with one embodiment of the present invention. First processor 570 and second processor 580 may be coupled to a chipset 590 via P-P interconnects 552 and 554, respectively. As shown in FIG. 5, chipset 590 includes P-P interfaces 594 and 598.

Furthermore, chipset 590 includes an interface 592 to couple chipset 590 with a high performance graphics engine 538. In turn, chipset 590 may be coupled to a first bus 516 via an interface 596. As shown in FIG. 5, various I/O devices 514 may be coupled to first bus 516, along with a bus bridge 518 which couples first bus 516 to a second bus 520. Various devices may be coupled to second bus 520 including, for example, a keyboard/mouse 522, communication devices 526 and a data storage unit 528 such as a disk drive or other mass storage device which may include code 530, in one embodiment. Further, an audio I/O 524 may be coupled to second bus 520.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A storage medium comprising content which, when executed by an accessing machine, causes the accessing machine to:
respond to a page fault by determining if the page fault resulted from a stack access;
create a superpage if the page fault did result from a stack access; and
create a translation lookaside buffer (TLB) entry for the superpage.

2. The storage medium of claim 1, further comprising content which, when executed by an accessing machine, causes the accessing machine to create a normal size page if the page fault did not result from a stack access.

3. The storage medium of claim 2, wherein the superpage comprises a plurality of contiguous normal size pages.

4. The storage medium of claim 2, wherein the normal size page comprises 4 kilobytes.

5. The storage medium of claim 2, wherein the superpage comprises 2 megabytes.

6. The storage medium of claim 2, wherein the superpage comprises a size chosen from a predetermined group of sizes.

7. The storage medium of claim 1, further comprising content which, when executed by an accessing machine, causes the accessing machine to create a superpage if the page fault did not result from a stack access.

8. The storage medium of claim 1, wherein the content to respond to a page fault by determining if the page fault resulted from a stack access comprises content to compare an access address to an address associated with a top of the stack.

9. A system comprising:
a processor including a first core to execute instructions, a translation lookaside buffer (TLB) coupled to the first core, the TLB to store a plurality of entries each having a translation portion to store a virtual address (VA)-to-physical address (PA) translation;
a dynamic random access memory (DRAM) coupled to the processor, the DRAM to store a page table including page table entries for a plurality of memory pages in the DRAM, the page table located in kernel level space; and
a page fault handler to create page table entries and TLB entries in response to a page fault, the page fault handler to determine if a page fault resulted from a stack access, to create a superpage table entry if the page fault did result from a stack access, and to create a TLB entry for the superpage.

10. The system of claim 9, further comprising the page fault handler to create a normal size page table entry if the page fault did not result from a stack access.

11. The system of claim 10, wherein the superpage comprises a plurality of contiguous normal size pages.

12. The system of claim 10, wherein the normal size page comprises 4 kilobytes.

13. The system of claim 10, wherein the superpage comprises a size chosen from a predetermined group of sizes.

14. The system of claim 9, further comprising the page fault handler to compare an access address to an address associated with a top of the stack.

15. A method comprising:
determining whether a the page fault resulted from a stack access;
creating a superpage if the page fault did result from a stack access; and
creating a translation lookaside buffer (TLB) entry for the superpage.

16. The method of claim 15, further comprising creating a normal size page if the page fault did not result from a stack access.

17. The method of claim 16, wherein the superpage comprises a plurality of contiguous normal size pages.

18. The method of claim 16, wherein the normal size page comprises 4 kilobytes.

19. The method of claim 16, wherein the superpage comprises 2 megabytes.

20. The method of claim 15, wherein determining whether the page fault resulted from a stack access comprises comparing an access address to an address associated with a top of the stack.
